(19) United States
(12) Patent Application Publication
(10) Pub. No.: US 2009/0067805 A1
(43) Pub. Date: Mar. 12, 2009

(54) Recording and reproducing device

(75) Inventors: Yoshito Kuroda, Kanagawa-ken (JP); Noriaki Fukutsu, Kanagawa-ken (JP)

Correspondence Address: THE NATH LAW GROUP, 112 South West Street, Alexandria, VA, 22314, US

(73) Assignee: VICTOR COMPANY OF JAPAN, LIMITED, Yokohama-shi (JP)

(21) Appl. No.: 12/232,012

(22) Filed: Sep. 9, 2008

(30) Foreign Application Priority Data
Sep. 10, 2007 (JP) 2007-234366
Sep. 3, 2008 (JP) 2008-226351

(51) Int. Cl. H04N 7/00; H04N 5/445

(52) U.S. Cl. 386/46; 725/38

(57) ABSTRACT

A content recording section records content data, and a play list generating section generates a play list based on the content data recorded in the content recording section. A link information storage section stores link information in which content data identification information is associated with play list identification information. A content list display control section displays a list of content data in a display section, and adds identification information indicating that the play list is stored in a play list storage section to the content data as the base of the play list based on the link information, to display the same on the display section.

### BACKGROUND OF THE INVENTION

1. Field of the Invention

The present invention relates to a recording and reproducing device which records and reproduces content data. More particularly, it relates to a recording and reproducing device which records and reproduces a play list generated on the basis of content data.

2. Description of the Related Art

In recent years, as a recording and reproducing device which records and reproduces content data concerning an image, there has been a device which stores a play list to define the reproduction order of scenes in the content data or the like to reproduce the content in accordance with this stored play list. The recording and reproducing device stores the play lists which is information for skipping the data of an image unnecessary for a user, for example, a commercial message image portion or the like, to reproduce the content data, and for changing the reproduction order to reproduce the content data. When the user selects a desired play list from the stored play lists, the recording and reproducing device reproduces the recorded content data in accordance with the selected play list.

In the conventional recording and reproducing device, a title list and a play list of the content data are displayed in separate display screens. Therefore, the user does sometimes not notice the presence of the play list of the desired content data though the play list is present, when selecting the content data to be viewed.

In Japanese Patent Application Laid-Open No. 2001-266459, a reproducing device is disclosed in which when the information (the content data) written in a recording medium is reproduced, there is read management information where a program list indicating the contents of the information written in the recording medium and a play list indicating the reproduction order of the written information designated by a viewer are written. The reproducing device reads the program list and the play list from the management information to generate and output a display screen which simultaneously displays the program list and the play list.

When the technology disclosed in Japanese Patent Application Laid-Open No. 2001-266459 is applied to a recording and reproducing device provided with a recording section having a large capacity, a large number of program lists and play lists are simultaneously displayed. Among the large number of the program lists and the play lists, it is difficult for the user to grasp a relation between a play list and a corresponding program list on the basis of which the play list is generated.

Therefore, in a case where the program list and the play list are simultaneously displayed and the user selects the content data to be viewed, even when the play list of the desired content data is present, the user sometimes selects the desired content data from the program list without noticing the presence of the play list. In this case, the user needs to view the contents while performing an operation of fast-forwarding commercial image portions, which is very laborious for the user.

In particular, in a case where the recording and reproducing device is used by a plurality of users, it occurs sometimes that a certain user performs an operation to generate and store a play list, and another user selects the content data without noticing the presence of the stored play list.

### SUMMARY OF THE INVENTION

The present invention has been developed in view of the above problem, and an object of the present invention is to provide a recording and reproducing device in which a user can easily confirm that a play list is prepared on the basis of content data. Another object of the present invention is to provide a recording and reproducing device in which a user can easily reproduce content data based on a play list.

To solve the above problem, the present invention provides the following recording and reproducing devices (a) to (e).

(a) A recording and reproducing device 1 comprising: a recording and reproducing control section 12 which controls recording and reproducing of content data; a content recording section 18a which records the content data; a play list generating section 11a which generates a play list indicating an order of reproduction of scenes that are at least a part of the content data based on one or a plurality of content data recorded in the content recording section; a play list storage section 18b which stores the play list therein; a link information storage section 14a which stores link information in which content data identification information for identifying the content data recorded in the content recording section is associated with play list identification information for identifying the play list; and a display control section 13a which displays, on a display section 2, a list of the content data prepared on the basis of the at least a part of the content data recorded in the content recording section and which adds identification information indicating presence of the play list prepared on the basis of the content data to the content data as the base of the play list stored in the play list storage section, based on the link information, to display the content data the identification information on the display section.

(b) The recording and reproducing device according to (a), wherein the list of the content data indicates at least one of a thumbnail image based on the content data and meta data of the content data.

(c) A recording and reproducing device 101 comprising: a recording and reproducing control section 12 which controls recording and reproducing of content data; a content recording section 18a which records the content data; a play list generating section 110a which generates a play list indicating an order of reproduction of scenes that are at least a part of the content data, based on one or a plurality of content data recorded in the content recording section; a play list storage section 18b which stores the play list therein; a link information storage section 14a which stores link information in which content data identification information for identifying the content data recorded in the content recording section is associated with play list identification information for identifying the play list; and a display control section 130b which displays, in a display section 2, a list of the content data prepared on the basis of at least a part of the content data recorded in the content recording section and, when one of the content data included in the list of the content data is selected and the play list that is generated on the basis of the selected content data is determined to be stored in the play list storage section based on the link information, displays, on the display section, a selection menu image having a menu for reproducing the play list that is generated on the basis of the selected content data.

(d) The recording and reproducing device according to (c), wherein the display control section adds identification information indicating presence of the play list prepared on the basis of the content data to the content data as the base of the play list stored in the play list storage section, based on the link information, to display the content data with the identification information on the display section.

(e) The recording and reproducing device according to (c), wherein the display control section displays, on the display section, a selection menu image having a menu for reproducing a plurality of play lists, respectively, when the plurality of play lists prepared on the basis of the selected content data are determined to be stored in the play list storage section.

According to the recording and reproducing device of the present invention, a user can easily confirm that the play list prepared using desired content data is recorded in the recording and reproducing device. Moreover, the user can easily reproduce the play list in the recording and reproducing device.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a block diagram showing the constitution of a recording and reproducing device according to a first embodiment;

FIG. 2 is a diagram showing a play list generation image in the recording and reproducing device of the first embodiment;

FIG. 3 is a flow chart showing the processing procedure of play list display processing in the recording and reproducing device of the first embodiment;

FIG. 4 is a diagram showing a list display image of images based on content data in the recording and reproducing device of the first embodiment;

FIG. 5 is a block diagram showing the constitution of a recording and reproducing device according to a second embodiment;

FIG. 6 is a diagram showing a play list generation image in the recording and reproducing device of the second embodiment;

FIG. 7 is a flow chart showing the processing procedure of play list display processing in the recording and reproducing device of the second embodiment;

FIG. 8 is a diagram showing a list display image of images based on content data in the recording and reproducing device of the second embodiment;

FIG. 9 is a diagram showing a selection menu image;

FIG. 10 is a diagram showing the selection menu image;

FIG. 11 is a diagram showing the selection menu image; and

FIG. 12 is a diagram showing the selection menu image.

### DESCRIPTION OF THE PREFERRED EMBODIMENTS

### First Embodiment

Hereinafter, the best mode for carrying out the present invention will be described with reference to the drawings.

In a first embodiment, a recording and reproducing device will be described in which a play list generated on the basis of content data is stored and in which the content data used for generating the play list is displayed while being associated with information, for example, an icon indicating that the play list is recorded.

Here, the content data includes image data, voice data and the content meta data, and one content data is constituted for each program unit. The content meta data is data which shows, in characters, information on content data such as a title of the content data, a body of the content data and a performer list. In the play list, at least a part of the content data is scenes, and the play list defines the reproduction order of one or a plurality of scenes. In some cases, the respective scenes are set from the plurality of content data, and the reproduction order is defined, thereby generating one play list. Then, the play list includes information indicating the content data from which the scene has been derived, time information containing a reproduction start time and a reproduction end time of each scene, and information indicating the reproduction order. It is to be noted that, instead of the reproduction end time, the time information may contain reproduction time elapsed from the reproduction start time.

### <<Constitution of a Recording and Reproducing Device>>

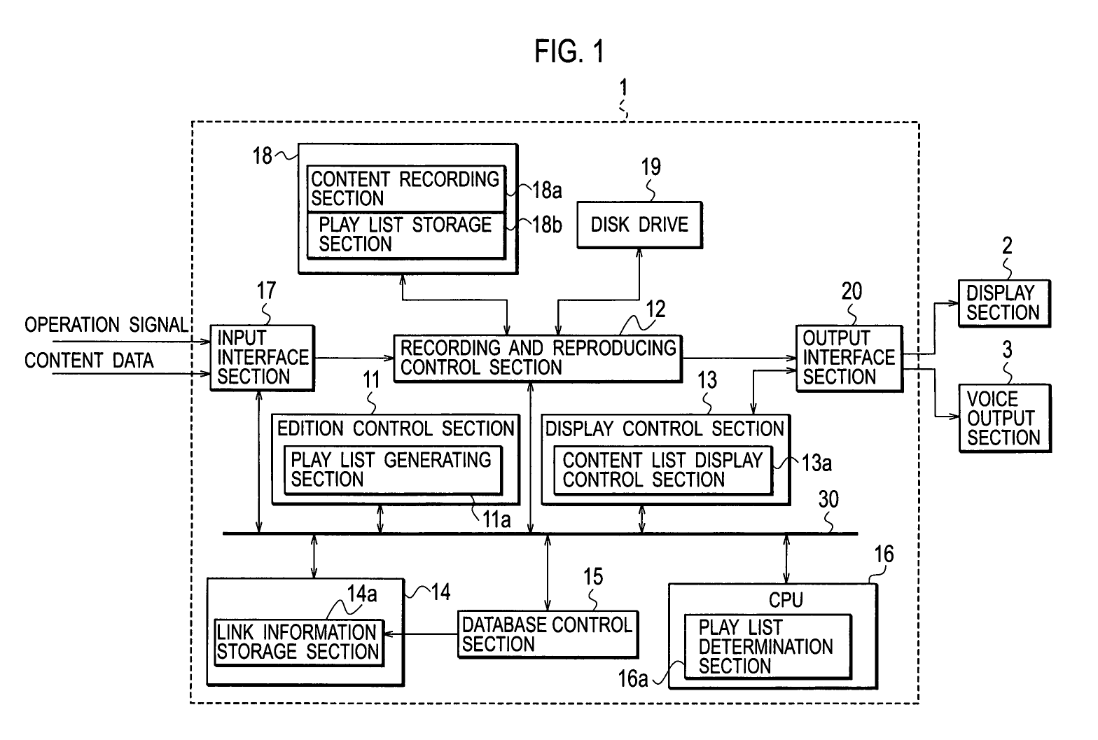

FIG. 1 is a block diagram showing the constitution of a recording and reproducing device 1 according to the first embodiment.

As shown in FIG. 1, the recording and reproducing device 1 is connected to a display section 2 and a voice output section 3, and it supplies an image signal for displaying an image to the display section 2 and further supplies a voice signal for outputting voice to the voice output section 3. The display section 2 is composed of, for example, a liquid crystal display, and the voice output section 3 is composed of, for example, a speaker.

The recording and reproducing device 1 includes an edition control section 11, a recording and reproducing control section 12, a display control section (a graphical user interface (GUI) control section) 13, a memory 14, a database control section 15, a CPU 16 and an input interface section 17, and these components are connected to one another via a bus 30. Furthermore, the recording and reproducing device 1 includes a recording section 18, a disk drive 19 and an output interface section 20. The input interface section 17, the recording section 18, the disk drive 19 and the output interface section 20 are connected to the recording and reproducing control section 12.

The edition control section 11 variously edits the content data recorded in the recording section 18 described later. Moreover, the edition control section 11 includes a play list generating section 11a.

The play list generating section 11a generates a play list based on the content data recorded in a content recording section 18a of the recording section 18 described later. The play list generating section 11a associates a play list with play list identification information (play list ID) which uniquely identifies the play list, to store the play list and the play list ID in a play list storage section 18b of the recording section 18 described later. Moreover, the play list generating section 11a additionally stores the play list ID in a link information storage section 14a of the memory 14 described later.

The recording and reproducing control section 12 records the content data input via the input interface section 17 in the content recording section 18a under the control of the CPU 16 described later. The content data includes image data, voice data and the content meta data. Furthermore, the recording and reproducing control section 12 associates the content data with content identification information (content ID) which uniquely identifies the content data to form the content information, and records the content information in the content recording section 18a.

Moreover, when new content information is recorded in the content recording section 18a, the recording and reproducing control section 12 additionally stores new content ID as link information in the link information storage section 14a.

When the reproduction of the content data is requested by user's operation, the recording and reproducing control section 12 reads the content data from the content recording section 18a. Moreover, when the reproduction of a play list is requested by the user's operation, the recording and reproducing control section 12 reads content data from the content recording section 18a based on the play list stored in the play list storage section 18b.

Then, the recording and reproducing control section 12 displays an image on the display section 2 based on the read content data via the output interface section 20, and outputs voice from the voice output section 3.

The display control section 13 includes a content list display control section 13a. The content list display control section 13a prepares a list of content data based on at least a part of content data recorded in the content recording section 18a of the recording section 18 described later, and displays the list of content data on the display section 2 via the output interface section 20.

Moreover, in a case where a play list determination section 16a of the CPU 16 described later determines that the play list ID corresponding to the content ID is stored in the link information storage section 14a described later, the content list display control section 13a adds identification information indicating that the play list is stored in the play list storage section 18b to the content data, in the content data list, corresponding to the relevant content ID, to display the data on the display section 2.

The memory 14 temporarily stores various programs to be executed by the CPU 16, and additionally stores data necessary for the CPU 16 to execute the programs and the like. Moreover, the memory 14 includes the link information storage section 14a. The link information storage section 14a stores link information. The link information includes the content IDs and play list IDs.

When the content recording section 18a records new content data, the corresponding content ID is stored as the link information in the link information storage section 14a. Moreover, when the play list generating section 11a generates a new play list, a play list ID corresponding to the new play list is stored as the link information in the link information storage section 14a. At this time, the play list ID is associated with the content ID corresponding to the content data used for generating the play list among the content IDs included in the link information, and is stored.

The database control section 15 variously controls the reading, writing and the like of the link information stored in the link information storage section 14a in accordance with a command from the CPU 16.

The CPU 16 reads various programs stored in the recording section 18, to execute this read program. Moreover, the CPU 16 includes the play list determination section 16a.

The play list determination section 16a reads the link information from the link information storage section 14a to determine whether or not a play list ID corresponding to a desired content ID is present in the read link information. In a case where the play list determination section 16a determines that the play list ID is stored in the link information storage section 14a, it is determined that a play list corresponding to the desired content ID is stored in the play list storage section 18b.

The input interface section 17 receives an operation signal or the content data from the outside, and supplies the signal or the data to the CPU 16, the recording and reproducing control section 12 and the like.

The recording section 18 stores various programs to be executed by the CPU 16. The recording section 18 is, for example, a hard disk. Moreover, the recording section 18 includes the content recording section 18a and the play list storage section 18b.

The content recording section 18a associates content data with a content ID to record the data as content information.

The play list storage section 18b associates a play list ID with a play list generated on the basis of content data recorded in the content recording section 18a, to store the play list ID and the play list.

The disk drive 19 reproduces, for example, the content data recorded in a recording medium, or record the content data therein.

The output interface section 20 receives the content data from the recording and reproducing control section 12, receives display image data or the like from the display control section 13, and supplies the data to the display section 2 and the voice output section 3.

It is to be noted that the content recording section 18a and the play list storage section 18b are disposed in the recording section 18, but may be disposed in recording mediums to be attached to the disk drive 19, respectively.

### <<Operation of Recording and Reproducing Device>>

An operation of the recording and reproducing device 1 according to the first embodiment will hereinafter be described.

The recording and reproducing device 1 performs play list generation processing and play list display processing.

The play list generation processing is to generate the play list based on content data and store the list. The play list display processing is to associate the content data with information indicating that the play list corresponding thereto is stored and to display the associated content data and information. The play list generation processing and the play list display processing will hereinafter be described in detail.

### <Play List Generation Processing>

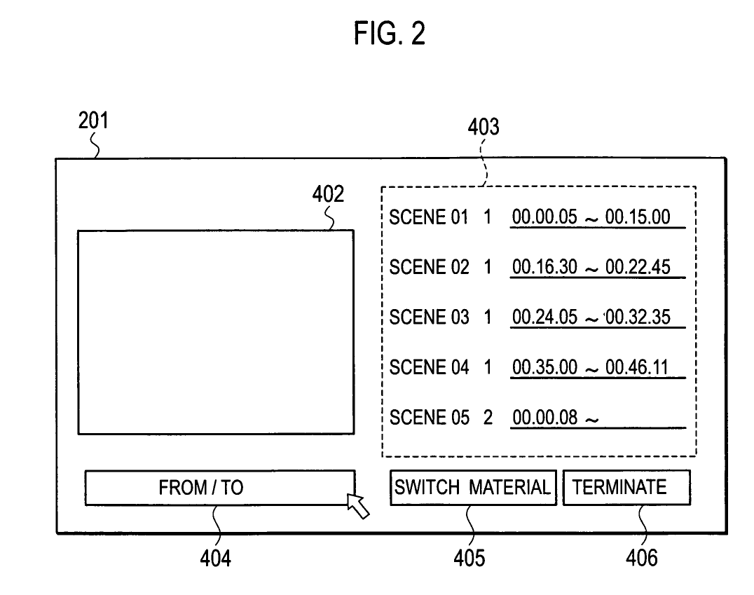

The play list generation processing in the recording and reproducing device 1 will be described with reference to FIGS. 1 and 2.

When the input interface section 17 supplies an operation signal indicating a request for displaying a play list generation image by the user's operation, the CPU 16 controls the display control section 13 so as to display the play list generation image on the display section 2.

FIG. 2 is a diagram showing one example of the play list generation image to be displayed on the display section 2 by the recording and reproducing device 1.

The play list generation image of the first embodiment is displayed in a display screen 201 of the display section 2. The play list generation image includes a content display region 402, a play list display region 403, a division generation button 404, a material switch button 405 and an edition end button 406. They are displayed in the predetermined positions on the display screen 201.

The content display region 402 is a region for displaying a content data image, and the play list display region 403 is a region for displaying a play list. The division generation button 404 is an image indicating a control of selecting a desired scene from the content data at the time of generating the play list. The scene is content data of a portion from first time (reproduction start time) to second time (reproduction end time) of the content data. The reproduction start time and the reproduction end time are time information attached to the content data.

The material switch button 405 is an image indicating a control of switching the content data to be displayed on the content display region 402. When a play list is generated on the basis of scenes derived from a plurality of content data, a user operates the material switch button 405. The edition end button 406 is an image indicating a control of ending the play list generation processing. The user operates the buttons 404 to 406 to generate the play list.

Upon receiving an operation signal indicating that the material switch button 405 was operated, the CPU 16 switches the content data to be read from the content recording section 18a of the recording section 18. The display control section 13 displays the image of the switched content data on the content display region 402.

The user selects a portion (a scene) to be used for a play list while viewing content data displayed on the content display region 402. The user operates the division generation button 404 at the start time of the portion to be used, and again operates the division generation button 404 at the end time of the portion.

Upon receiving an operation signal indicating that the division generation button 404 was operated, the CPU 16 outputs a control signal to the play list generating section 11a of the edition control section 11.

Based on the control signal, the play list generating section 11a generates the time information of the selected scene based on the time information of the content data at a time when the division generation button 404 is operated and the time information of the content data at a time when the division generation button 404 is operated next. The scene time information includes the reproduction start time and the reproduction end time of the scene based on the time information of the content data. The play list generating section 11a displays the scene time information on the play list display region 403 via the display control section 13. The play list generating section 11a further displays, on the play list display region 403, information indicating the content data from which the scene has been derived.

The display on the play list display region 403 will be described with reference to the uppermost line shown in the play list display region 403 of FIG. 2. “Scene 01” is the name of the scene, and the user may arbitrarily name the scene. “1” following the “Scene 01” is information indicating the used content data, and here indicates that Content Data 1 has been used, but the content ID may be displayed instead. “00.00.05 to 00.15.00” following “1” is the time information of Scene 01.

The play list generating section 11a generates the time information of one scene, every time the division generation button 404 is operated twice.

As described above, the user selects one or a plurality of scenes, and determines the reproduction order of the selected scenes to generate the play list. When the preparation of the play list is completed, the user operates the edition end button 406.

The CPU 16 continues the reproduction of the content data displayed on the content display region 402, until the edition end button 406 is operated. Upon receiving an operation signal indicating that the edition end button 406 was operated, the CPU 16 allows the recording and reproducing control section 12 to stop the reproduction of the content data, and allows the play list generating section 11a to complete the play list generation processing. The CPU 16 allows the display control section 13 to end the display of the play list generation image in the display section 2.

The play list generating section 11a outputs, to the play list storage section 18b, information (the play list) indicating the time information and the reproduction order of the selected scenes and the play list ID which uniquely identifies the generated play list. The play list is associated with the play list ID and stored in the play list storage section 18b.

Furthermore, the play list generating section 11a stores the play list ID in the link information storage section 14a in association with the content ID corresponding to the content data used for generating the play list among the content IDs in the link information stored in the link information storage section 14a. As described above, the play list may be prepared on the basis of a plurality of content data. In this case, the play list generating section 11a associates each content ID of the used content data with the play list ID to store the content IDs and the play list ID in the link information storage section 14a.

As described above, the play list generating section 11a can generate the play list based on the operation signals indicating that the buttons 404 to 406 of the play list generation image have been operated.

### <Play List Display Processing>

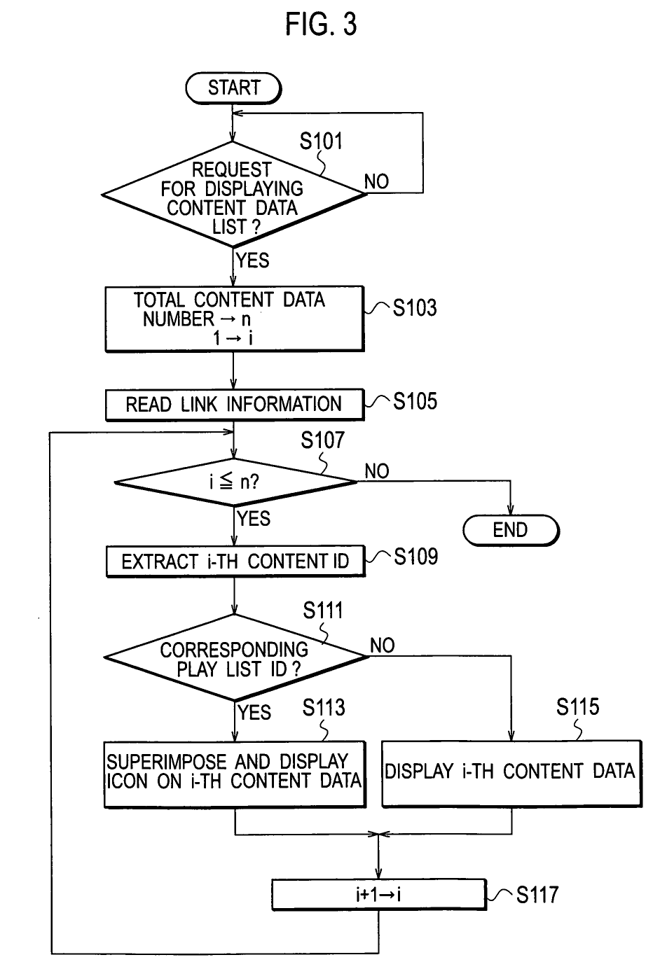

FIG. 3 is a flow chart showing the processing procedure of the play list display processing of the recording and reproducing device 1.

In step S101, the CPU 16 determines whether or not an operation signal indicating a request for displaying a list of content data has been supplied from the input interface section 17. When an operation signal indicating the request for displaying the list of content data was supplied from the input interface section 17, the processing of the CPU 16 shifts to step S103.

In the step S103, the play list determination section 16a of the CPU 16 calculates the number of all the content data recorded in the content recording section 18a. It is supposed that this calculated total content data number is n. Furthermore, the play list determination section 16a inputs “1” as an initial value to a counter i.

Next, in step S105, the play list determination section 16a reads link information from the link information storage section 14a of the memory 14 via the database control section 15.

In step S107, the play list determination section 16a determines whether or not the counter i is the total content data number of n or less. In a case where it is determined that the counter i is n or less, the processing advances to step S109 in which the play list determination section 16a extracts the i-th content ID from the content information recorded in the content recording section 18a of the recording section 18.

In a case where it is determined in the step S107 that the counter i is larger than the total content data number n, the play list determination section 16a ends the play list display processing.

The play list determination section 16a determines in step S111 whether or not a play list corresponding to the extracted i-th content ID is present. Specifically, the play list determination section 16a determines whether or not a play list ID corresponding to the i-th content ID is present in the link information read in the step S105. In a case where it is determined that a play list ID corresponding to the read i-th content ID is present, the processing advances to step S113.

In the step S113, the CPU 16 controls the display control section 13 as follows. The content list display control section 13a of the display control section 13 displays the content data corresponding to the i-th content ID on the display section 2. In the present embodiment, as described later, a thumbnail image and the content information based on the image data of the content data are displayed on the display section 2.

Furthermore, the content list display control section 13a displays, on the display section 2, an icon as the information indicating that a play list corresponding to the i-th content ID is present, in association with the content data corresponding to the i-th content ID.

On the other hand, in a case where the play list determination section 16a determines in the step S111 that a play list ID corresponding to the extracted i-th content ID is not present, the processing advances to step S115. In the step S115, the CPU 16 instructs the content list display control section 13a to display only the content data corresponding to the i-th content ID in the display section 2.

When the processing of the steps S113 and S115 ends, the processing advances to step S117. In the step S117, the play list determination section 16a adds “1” to the counter i. Afterward, the CPU 16 repeats the processing of the steps S107 to S117 until the counter i becomes larger than n (i>n). In consequence, the image based on all the content data recorded in the content recording section 18a of the recording section 18 can be displayed on the display section 2.

One content data may be used for generating a plurality of play lists. In this case, a content ID of link information is associated with a plurality of play list IDs, and is stored. In a case where the play list determination section 16a determines in the step S111 that there are a plurality of corresponding play list IDs, in the step S113, a plurality of icons may be displayed, or an icon indicating that the plurality of play lists are present may be displayed.

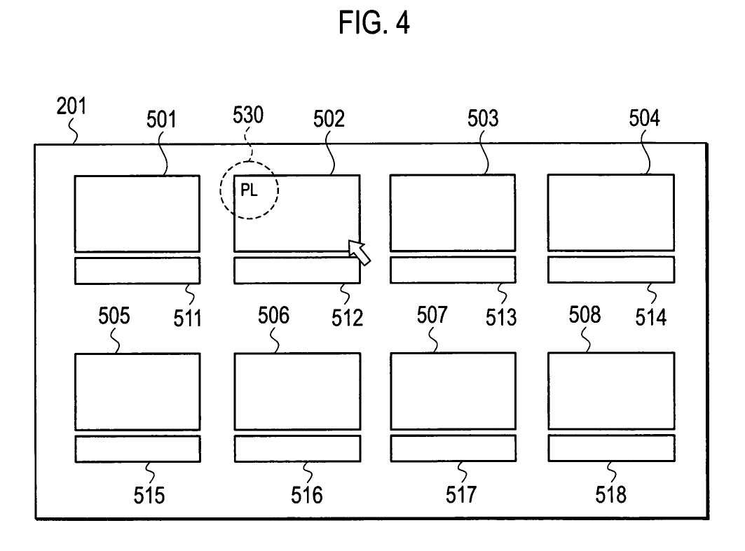

FIG. 4 is a diagram showing a state in which the recording and reproducing device 1 displays a list of content data in the display section 2. In a case where the CPU 16 determines in the step S101 shown in FIG. 3 that an operation signal indicating a display request has been supplied, the list of content data is displayed on the display section 2. The display screen 201 displays thumbnail images 501 to 508 and content information pieces 511 to 518. Each of the thumbnail images displays a frame of the content data. An icon 530 is superimposed and displayed on the thumbnail image 502.

The content list display control section 13a displays the thumbnail images 501 to 508 and the content information pieces 511 to 518 on the predetermined display regions of the display section 2. The thumbnail image 501 and the content information piece 511 are based on the same content data. The thumbnail images 502 to 508 have a similar relation with the content information pieces 512 to 518.

Here, the content information pieces 511, 513 to 518 are the content information corresponding to such content IDs that the play list determination section 16a determines that a play list corresponding to each content ID is not stored. The content information piece 512 is the content information corresponding to such a content ID that the play list determination section 16a determines that a play list corresponding to the content ID is stored.

The content list display control section 13a further displays, on the display section 2, the content information piece 512 together with the icon 530. Here, the icon 530 is superimposed and displayed on the thumbnail image 502, but the icon 530 may be superimposed and displayed on the content information piece 512, or may be displayed around a region where the thumbnail image and the content information piece 512 are displayed.

The icon 530 is identification information (play list storage identification information) indicating that a play list ID is stored in the link information storage section 14a. That is, it is indicated that a play list generated on the basis of the content data indicated by the content information provided with the icon 530 is stored in the play list storage section 18b. The play list storage identification information is not limited to the icon, and may be, for example, character information indicating that the play list is stored.

In the present embodiment, according to an instruction for displaying a content data list, the thumbnail images 501 to 508 and the content information pieces 511 to 518 are displayed on the display screen 201. However, either the thumbnail images 501 to 508 or the content information pieces 511 to 518 may be displayed.

The recording and reproducing device 1 of the first embodiment stores the play list generated on the basis of the content data, and may associate the image based on the content data with the information (the icon) indicating that a play list is stored and display the image and the information on the display section 2.

The user confirms, from the display section 2, the presence of a display of an image based on content data to be viewed and an icon corresponding thereto, and thus can easily determine whether or not a play list of the content data to be viewed is stored in the recording and reproducing device.

### Second Embodiment

In a second embodiment, a recording and reproducing device will be described in which when an image based on content data used in a play list is selected, a selection menu image capable of selecting the reproduction of the content data and the reproduction of the play list is displayed.

### <<Constitution of Recording and Reproducing Device>>

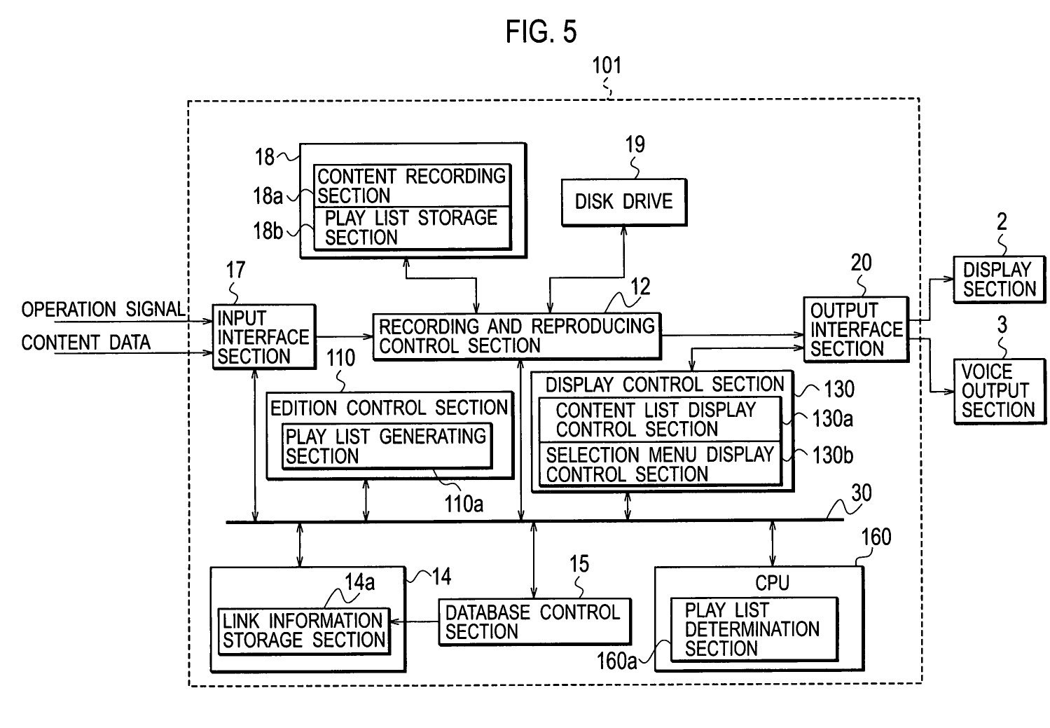

FIG. 5 is a block diagram showing a constitution of a recording and reproducing device 101 according to the second embodiment. The same constitution as that of the recording and reproducing device 1 according to the first embodiment is denoted with the same reference numerals, and the description thereof is omitted.

As shown in FIG. 5, the recording and reproducing device 101 is connected to a display section 2 and a voice output section 3. The recording and reproducing device 101 supplies an image signal to the display section 2, and supplies a voice signal to the voice output section 3.

The recording and reproducing device 101 includes an edition control section 110, a recording and reproducing control section 12, a display control section 130, a memory 14, a database control section 15, a CPU 160 and an input interface section 17, and these components are connected to one another via a bus 30. Furthermore, the recording and reproducing control section 12 is connected to a recording section 18, a disk drive 19 and an output interface section 20.

Here, the recording and reproducing control section 12, the memory 14, the database control section 15, the input interface section 17, the recording section 18, the disk drive 19 and the output interface section 20 have the same constitutions as those of the recording and reproducing device 1, and hence the description thereof is omitted.

The edition control section 110 variously edits content data recorded in the recording section 18. Moreover, the edition control section 110 includes a play list generating section 110a.

The play list generating section 110a generates a play list based on the content data recorded in a content recording section 18a of the recording section 18, and associates the play list with play list ID to store the play list and the play list ID in a play list storage section 18b. Moreover, the play list generating section 110a additionally stores the play list ID in association with content ID corresponding to the content data in link information stored in a link information storage section 14a.

The display control section 130 includes a content list display control section 130a and a selection menu display control section 130b.

The content list display control section 130a prepares a list of content data based on at least a part of content data recorded in the content recording section 18a, and displays the list of content data on the display section 2 via the output interface section 20. Moreover, in a case where a play list determination section 160a of the CPU 160 described later determines that the play list ID corresponding to the content ID is stored in the link information storage section 14a described later, the content list display control section 130a adds identification information indicating that the play list is stored in the play list storage section 18b to the content data, in the content data list, corresponding to the relevant content ID, to display the data on the display section 2. The identification information is play list storage identification information (an icon or the like) described above.

The selection menu display control section 130b displays a selection menu image described later on the display section 2. The selection menu display control section 130b stores the selection menu image.

The CPU 160 reads various programs stored in the recording section 18, to execute the read program. Moreover, the CPU 160 includes the play list determination section 160a.

The play list determination section 160a reads the link information from the link information storage section 14a to determine whether or not a play list ID corresponding to a desired content ID is present in the read link information. In a case where the play list determination section 160a determines that the play list ID is stored in the link information storage section 14a, it is determined that a play list corresponding to the desired content ID is stored in the play list storage section 18b.

When an operation signal indicating that one content data be selected from the list of the content data displayed in the display section 2 is supplied from the outside via the input interface section 17, the CPU 160 reads content information including the content data selected from the content recording section 18a. Moreover, the CPU 160 reads the link information from the link information storage section 14a. The play list determination section 160a extracts the content ID from the read content information, and determines that a play list corresponding to the extracted content ID is stored in the play list storage section 18b of the recording section 18.

### <<Operation of Recording and Reproducing Device>>

An operation of the recording and reproducing device 101 according to the second embodiment will hereinafter be described.

The recording and reproducing device 101 performs play list generation processing, play list display processing and menu image display processing. The play list generation processing and the play list display processing are similar to those of the first embodiment. The menu image display processing is to display the selection menu image with respect to the content data selected by a user, so that control such as the reproduction of the content data can be selected. The play list generation processing, the play list display processing and the menu image display processing will be described in detail.

### <Play List Generation Processing>

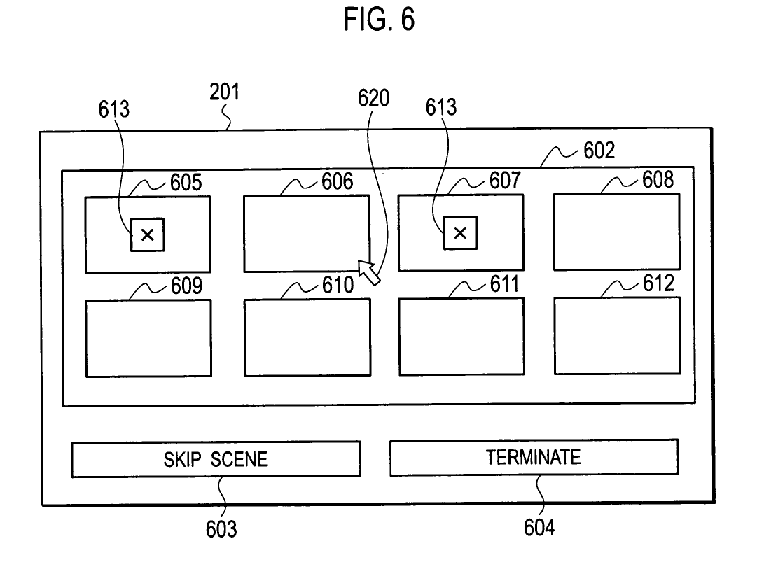

The play list generation processing in the recording and reproducing device 101 will be described with reference to FIGS. 5 and 6.

When the input interface section 17 supplies the operation signal indicating a request for displaying a play list generation image by the user's operation, the CPU 160 controls the display control section 130 so as to display the play list generation image on the display section 2.

FIG. 6 is a diagram showing one example of the play list generation image to be displayed on the display section 2 by the recording and reproducing device 101.

On a display screen 201 of the display section 2, the play list generation image of the second embodiment is displayed. The play list generation image includes a scene display region 602, a scene skip button 603 and an edition end button 604, and they are displayed in the predetermined positions of the display screen 201. In the scene display region 602, thumbnail images 605 to 612 described later are displayed.

The play list generating section 110a of the edition control section 110 automatically divides the selected content data into a plurality of predetermined scenes. The content data may be selected by an arbitrary method.

The method for dividing the content data is, for example, a method of dividing a frame image constituting the content data into a plurality of regions, and obtaining a motion vector between the frame images with respect to each of the regions. The play list generating section 110a calculates scene divisions from the motion vector, and divides the content data based on the calculated scene divisions. Here, each of the scenes (the content data for each scene) generated by dividing the content data is a provisional play list candidate. In the present embodiment, the content data is divided into eight scenes, but the number of the divisions is not limited to this example.

The display control section 130 displays, on the display section 2, the thumbnail images 605 to 612 each displaying a frame of the corresponding scene. In the present embodiment, the user determines an unnecessary scene from the automatically prepared scenes to prepare a desired play list. The user views the thumbnail images 605 to 612 displayed on the display section 2 to select the scene unnecessary for the play list. The unnecessary scene is, for example, a commercial message or the like.

In a case where an operation signal indicating that one of the thumbnail images 605 to 612 was selected is supplied to the play list generating section 110a, the scene as the base of the selected thumbnail image can be edited. FIG. 6 shows a state in which the thumbnail image 606 is selected. The selection of the thumbnail image 606 is displayed by displaying a marker 620 on the thumbnail image 606, but a display method is not limited to this method. The display frame of the thumbnail image may be thickened, or the color of the image may be changed when displayed.

When the scene is editable, the user can operate the scene skip button 603. When the scene skip button 603 is operated, the CPU 160 supplies, to the play list generating section 110a, a signal indicating that the editable scene be skipped. The play list generating section 110a deletes the editable scene from the play list candidates.

The display control section 130 superimposes and displays, on the thumbnail image, a deletion mark 613 indicating that the scene has been deleted.

As shown in FIG. 6, the deletion marks 613 are superimposed and displayed on the thumbnail images 605, 607. Therefore, the user can recognize that the scenes corresponding to the thumbnail images 605, 607 have been deleted from the play list candidates.

When the deletion of the unnecessary scenes ends, the user operates the edition end button 604. Upon receiving an operation signal indicating that the edition end button 604 was operated, the CPU 160 allows the play list generating section 110a to complete the play list generation processing. Moreover, the CPU 160 allows the display control section 130 to end the display of the play list generation image on the display section 2.

The play list generating section 110a generates the information (the play list) including time information indicating the reproduction start time and reproduction end time of each of the scenes (here, corresponding to the thumbnail images 606, 608 to 612) which have not been deleted and information indicating the reproduction order of the scenes. The play list generating section 110a outputs, to the play list storage section 18b, the play list and the play list ID which uniquely identifies the play list. The play list is associated with the play list ID and stored in the play list storage section 18b.

Furthermore, the play list generating section 110a stores the play list ID in the link information storage section 14a in association with the content ID corresponding to the content data used for generating the play list among the content IDs in the link information stored in the link information storage section 14a.

In the second embodiment, the recording and reproducing device 101 automatically prepares a scene from a content data selected. The user determines whether or not to delete the scenes from the play list, while viewing the thumbnail images 605 to 612 displayed on the display section 2. The user performs an operation of deleting (skipping) the scenes unnecessary for the play list. Therefore, the play list generating section 110a can generate a play list in which the scenes unnecessary for the user are deleted from the content data.

As described above, the recording and reproducing device 101 generates and stores a play list as reproduction order information so that images unnecessary for the user are skipped from one content data during the reproduction based on the user's operation.

The recording and reproducing device 101 may perform the play list generation processing described in the first embodiment.

### <Print List Display Processing and Menu Image Display Processing>

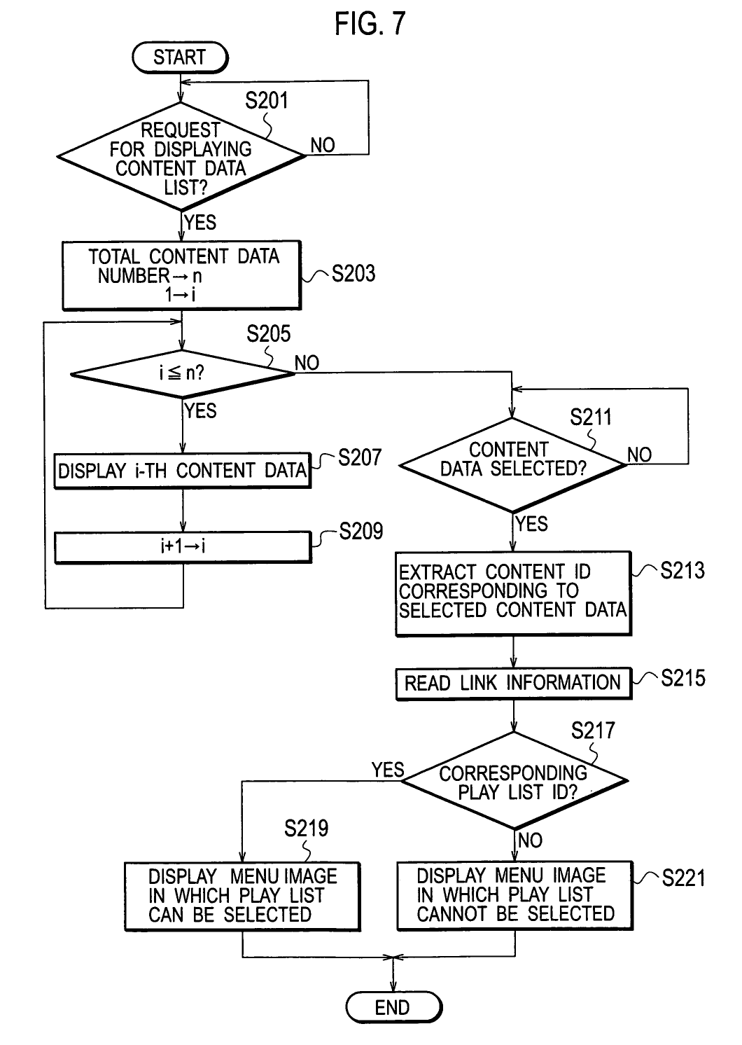

FIG. 7 is a flow chart showing a processing procedure of the play list display processing and the menu image display processing of the recording and reproducing device 101.

In step S201, the CPU 160 determines whether or not an operation signal indicating a request for displaying a list of content data was supplied from the input interface section 17. When the operation signal indicating the request for displaying the list of content data is supplied from the input interface section 17, the processing of the CPU 160 shifts to step S203.

In the step S203, the CPU 160 allows the content list display control section 130a to calculate the number of all the content data recorded in the content recording section 18a. It is supposed that this calculated total content data number is n. Furthermore, the content list display control section 130a inputs “1” as an initial value to a counter i.

In step S205, the content list display control section 130a determines whether or not the counter i is the total content data number of n or less. In a case where it is determined that the counter i is n or less, the processing advances to step S207 in which the CPU 160 allows the content list display control section 130a to read the i-th content data from the content recording section 18a of the recording section 18. The content list display control section 130a displays the read content data on the display section 2. In the present embodiment, as described above, thumbnail images and content information based on the image data of the content data are displayed on the display section 2.

In step S209, the content list display control section 130a adds only “1” to the counter i. Afterward, the CPU 160 allows the content list display control section 130a to repeat the processing of the steps S205 to S209 until the counter i becomes larger than n (i>n). In consequence, lists of all the content data recorded in the content recording section 18a of the recording section 18 can be displayed on the display section 2.

In a case where it is determined in the step S205 that the counter i exceeds the total content data number n, the processing advances to step S211. In the step S211, the CPU 160 determines whether or not an operation signal for selecting one content data from the content data list displayed on the display section 2 was input. In a case where it is determined that the operation signal was input from the input interface section 17, the CPU 160 shifts the processing to step S213.

In the step S213, the play list determination section 160a reads, from the content recording section 18a, content information including the selected content data. Furthermore, the play list determination section 160a extracts a content ID from the content information.

Then, the play list determination section 160a reads link information from the link information storage section 14a via the database control section 15 in step S215.

The play list determination section 160a determines in step S217 whether or not a play list ID corresponding to the extracted content ID is stored in the play list storage section 18b. Specifically, the play list determination section 160a determines whether or not a play list ID corresponding to the content ID extracted in the step S213 is present in the link information read in the step S215. In a case where it is determined that a play list ID is present in the link information, it is determined that a play list corresponding to the extracted content ID is stored in the play list storage section 18b.

Then, in a case where it is determined in the step S217 that a play list corresponding to the extracted content ID is stored, the processing advances to step S219. In the step S219, the selection menu display control section 130b of the display control section 130 displays a selection menu image on the display section 2. The selection menu image is a menu in which the reproduction of content data based on the play list can be selected.

On the other hand, in a case where it is determined in the step S217 that any play list corresponding to the extracted content ID is not stored, the processing advances to step S221. In the step S221, the selection menu display control section 130b of the display control section 130 displays a selection menu image on the display section 2. The selection menu image is a menu in which the reproduction of content data can be selected but the reproduction of content data based on the play list cannot be selected.

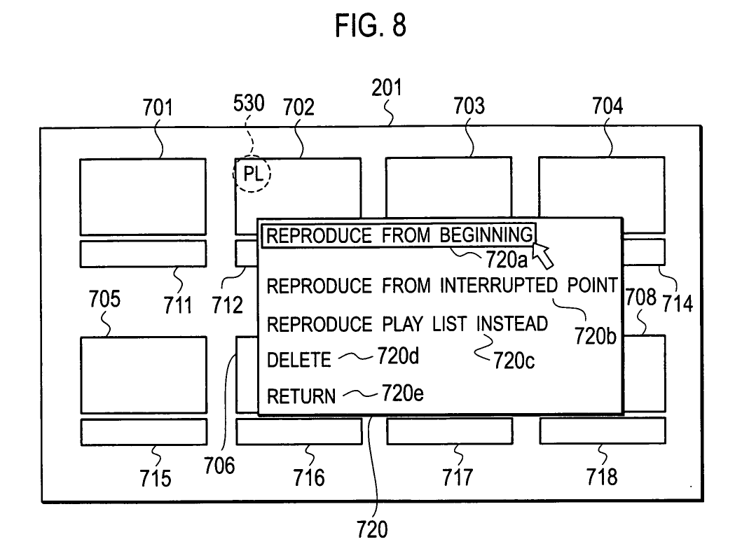

FIG. 8 is a diagram showing a state in which the recording and reproducing device 101 displays a list of content data on the display section 2. In a case where the CPU 160 determines in the step S201 shown in FIG. 7 that an operation signal indicating a display request was supplied, a content data list is displayed on the display section 2.

The display screen 201 displays thumbnail images 701 to 708 and content information pieces 711 to 718. The thumbnail image 701 and the content information piece 711 are based on the same content data. The thumbnail images 702 to 708 have a similar relation with the content information pieces 712 to 718. An icon 530 is superimposed and displayed on the thumbnail image 702. Moreover, the display screen 201 displays a selection menu image 720.

When one thumbnail image is selected from the displayed thumbnail images 701 to 708, an operation signal indicating the selection is supplied to the play list determination section 160a of the CPU 160 (the step S211 of FIG. 7). The play list determination section 160a determines whether or not a play list ID associated with a content ID of the content data indicated by the operation signal is stored in the link information storage section 14a.

In a case where the play list determination section 160a determines that the play list ID is stored in the link information storage section 14a, the selection menu display control section 130b displays, on the display section 2, the selection menu image 720 in which the reproduction of the content data based on the play list can be selected. The CPU 160 controls the selection menu display control section 130b so as to display the selection menu image on the display section 2.

In a case where the play list determination section 160a determines that the play list ID is not stored in the link information storage section 14a, the selection menu display control section 130b displays a selection menu image 721 on the display section 2.

The selection menu image 720 is displayed on the display section 2 with respect to the content data selected for the first time in FIG. 8. Furthermore, when a menu item “reproduce from the beginning” 720a described later is selected, the CPU 160 controls the recording and reproducing control section 12 so as to reproduce the content data from the beginning. The selection menu display control section 130b continues displaying the selection menu image 720 until the selected content data is reproduced once.

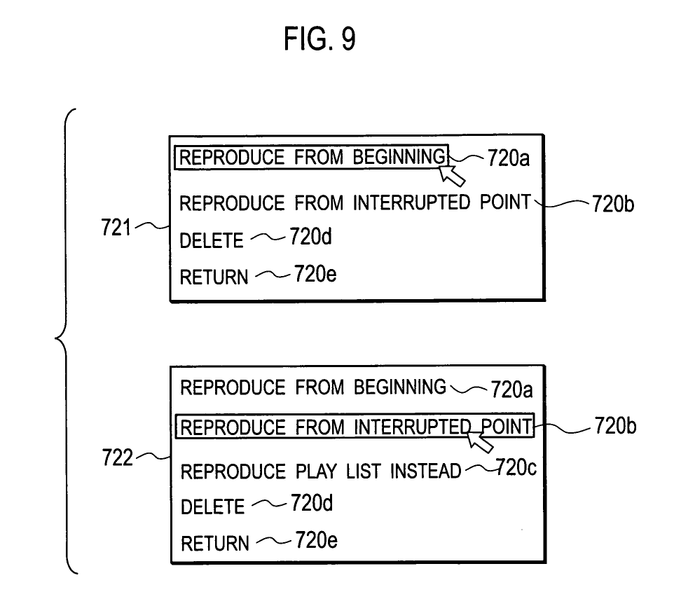

When the content data reproduced once or more is selected, the CPU 160 displays a selection menu image 722 shown in FIG. 9 on the display section 2. However, when the content data is reproduced to the last, the CPU 160 displays the selection menu image 720 on the display section 2.

The selection menu image 720 includes the menu item 720a, and menu items 720b to 720e. The CPU 160 controls the sections based on the selected menu items 720a to 720e. When the menu item “reproduce from the beginning” 720a is selected, the CPU 160 controls the recording and reproducing control section 12 so as to reproduce the content data from the beginning. When the menu item “reproduce from the interrupted point” 720b is selected, the CPU 160 allows the recording and reproducing control section 12 to execute the reproduction of the content data from a time when the viewing was last interrupted. The CPU 160 stores the time of the content data when the reproduction of the content data was interrupted.

When the menu item “reproduce the play list instead” 720c is selected, the CPU 160 allows the recording and reproducing control section 12 to execute the reproduction of the content data based on the play list generated using the selected content data. Furthermore, when the menu item “delete” 720d is selected, the CPU 160 deletes the content data from the content recording section 18a. When the menu item “return” 720e is selected, the CPU 160 controls the selection menu display control section 130b so as to terminate the display of the selection menu image.

The selection menu image 720 has a state in which the menu item “reproduce from the beginning” 720a is selected. Afterward, when the user performs an operation of pressing a determination button or the like, the CPU 160 determines that the menu item “reproduce from the beginning” 720a has been selected. The menu item which is to be selected is displayed by surrounding a menu content by a square. There is not any special restriction on a displaying method as long as the menu item can be distinguished from the other menu items. For example, a method of changing the thickness of item characters, the color of the characters, the size of the characters or the like may be performed. The user can change the menu item to be selected with a remote controller or the like.

In a case where the selected content data is reproduced for the first time, even when the menu item “reproduce from the interrupted point” 720b is selected, the CPU 160 may control the recording and reproducing control section 12 so as to start the reproduction from the beginning. Alternatively, a state in which the menu item “reproduce from the interrupted point” 720b cannot be selected, that is, an error or the like may be displayed.

FIG. 9 shows the selection menu images 721, 722. The selection menu image 721 is displayed on the display section 2 in the step S221 of FIG. 7. In the selection menu image 721, the menu item “reproduce the play list instead” 720c is removed from the menu items 720a to 720e included in the selection menu image 720. In a case where the play list determination section 160a determines that a play list ID corresponding to the content ID of the content data selected in FIG. 8 is not stored, the CPU 160 controls the selection menu display control section 130b so as to display the selection menu image 721 on the display section 2.

The selection menu image 722 has a state in which the menu item “reproduce from the interrupted point” 720b is beforehand selected. The selection menu image is appropriately changed so that the menu item having a high possibility that the item is selected by the user is easily selected. The menu items 720a to 720e included in the selection menu image 722 are the same as those of the selection menu image 720, and hence the description thereof is omitted.

Instead of the selection menu image 722, an image (not shown) in which the menu item “reproduce from the interrupted point” 720b is displayed on the top of a plurality of menu items may be displayed on the display section 2. The selection menu image may be displayed in which the arrangement order of the menu items is changed so that the menu item having a high possibility of being selected by the user is arranged so as to be easily selected from the menu items included in the selection menu image.

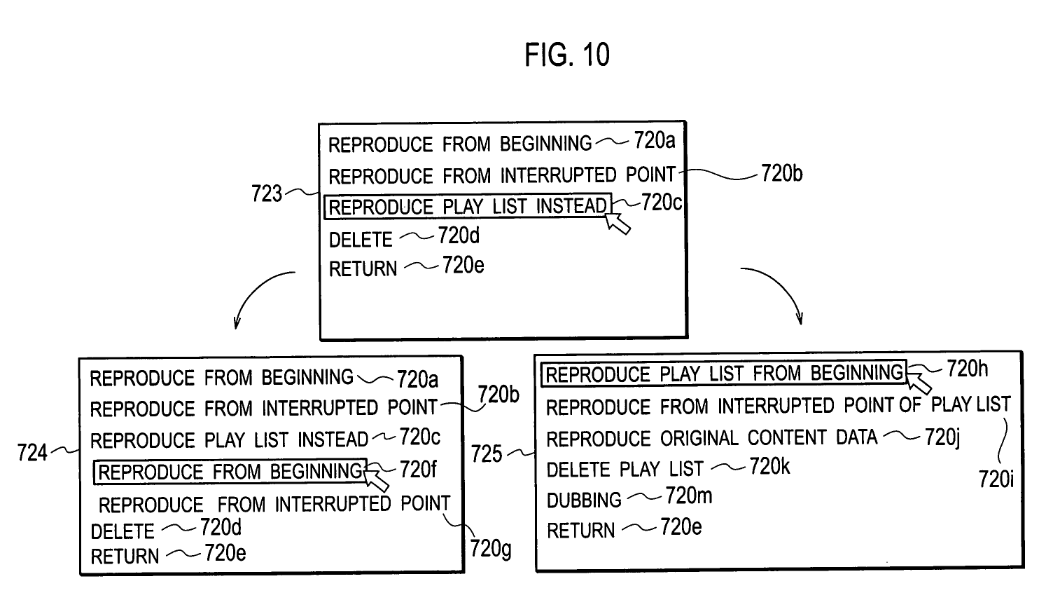

FIG. 10 shows selection menu images 723 to 725. The menu items 720a to 720e included in the selection menu image 723 are the same as those of the selection menu image 720, and hence the description thereof is omitted. When the menu item “reproduce the play list instead” 720c is selected from the selection menu image 723, the CPU 160 allows the selection menu display control section 130b to display the selection menu image 724 on the display section 2. The selection menu image 724 includes a menu item “reproduce from the beginning” 720f and a menu item “reproduce from the interrupted point” 720g which are sub-menu items of the menu item “reproduce the play list instead” 720c. The other menu items included in the selection menu image 724 are the same as those of the selection menu image 723, and hence the description thereof is omitted.

When the menu item “reproduce from the beginning” 720f is selected, the CPU 160 controls the recording and reproducing control section 12 so as to reproduce the play list from the beginning. Similarly, when the menu item “reproduce from the interrupted point” 720g is selected, the CPU 160 controls the recording and reproducing control section 12 so as to reproduce the play list from the time when the viewing of the play list was previously viewed.

When the recording and reproducing device 101 reproduces the selected play list for the first time, the selection menu display control section 130b preferably displays, on the display section 2, the selection menu image 724 having a state in which the menu item “reproduce from the beginning” 720f may be selected. When the play list is reproduced for the second time or more, a menu image (not shown) having a state in which the menu item “reproduce from the interrupted point” 720g may be selected is preferably displayed on the display section 2. Alternatively, a selection menu image in which the display order of the menu items has been changed from that of the selection menu image 724 may be displayed on the display section 2.

When the menu item “reproduce the play list instead” 720c is selected, the CPU 160 may display a selection menu image 725 on the display section 2. The selection menu image 725 includes menu items 720e, 720h to 720k and 720m. When the menu item “reproduce the play list from the beginning”720h is selected, the CPU 160 controls the recording and reproducing control section 12 so as to reproduce the play list from the beginning. When the menu item “reproduce from the interrupted point of the play list” 720i is selected, the CPU 160 allows the recording and reproducing control section 12 to execute the reproduction of the play list from the time when the viewing was previously interrupted. When the menu item “reproduce original content data” 720j is selected, the CPU 160 allows the recording and reproducing control section 12 to execute the reproduction of the selected content data. Furthermore, when the menu item “delete the play list” 720k is selected, the CPU 160 deletes the play list from the play list storage section 18b. When the menu item “dubbing” 720m is selected, the CPU 160 records the content data based on the play list in a recording medium via the disk drive 19 shown in FIG. 5. When the menu item “return” 720e is selected, the CPU 160 controls the selection menu display control section 130b so as to end the display of the selection menu image 725 on the display section 2.

The CPU 160 stores, in the play list, the time when the reproduction of the content data based on the play list was interrupted. When the menu item “reproduce from the interrupted point of the play list” 720i is selected, the CPU 160 controls the recording and reproducing control section 12 so as to resume the reproduction of the content data from the time when the play list is interrupted.

When the recording and reproducing device 101 reproduces the play list selected in the same manner as described above for the second time or more, the selection menu display control section 130b displays, on the display section 2, a selection menu image (not shown) having a state in which the menu item “reproduce from the interrupted point of the play list” 720i may be selected.

It is to be noted that when the menu item “reproduce the play list instead” 720c is selected, the CPU 160 may start the reproduction of the play list without displaying the above selection menu images 724, 725.

### Third Embodiment

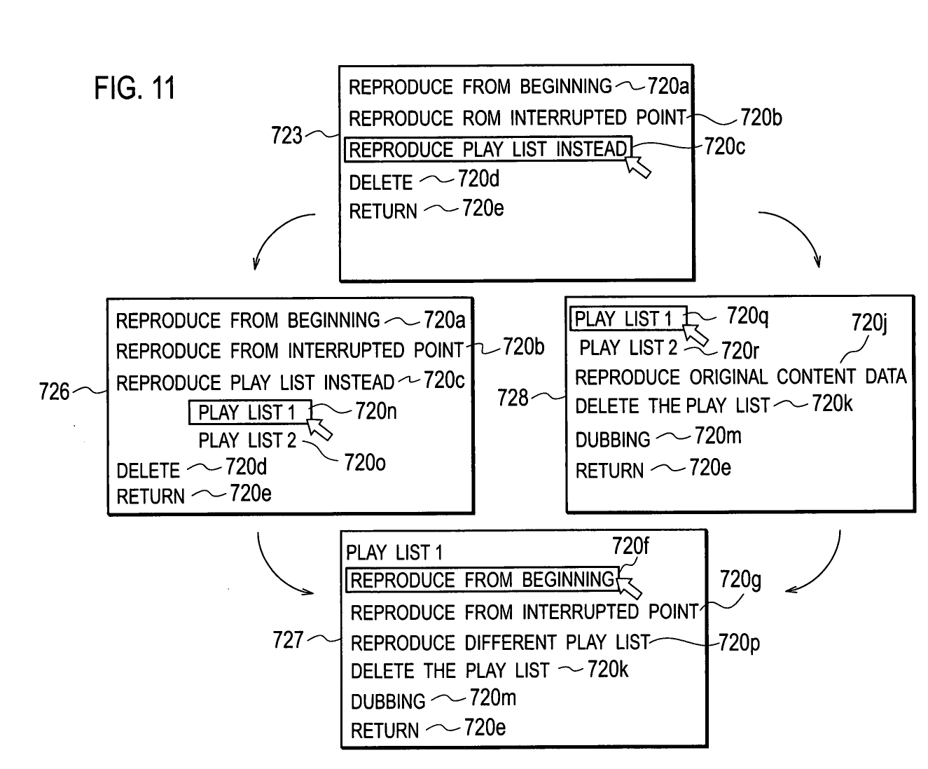

FIG. 11 shows selection menu images 723, 726 to 728 according to a third embodiment. The same menu items included in the selection menu images 726 to 728 as the above-mentioned menu items are denoted with the same reference numerals, and the description thereof is omitted. In the second embodiment, the operation of the recording and reproducing device 101 has been described in a case where one play list is generated from one content data. In the third embodiment, there will be described an operation of the recording and reproducing device 101 in a case where a plurality of play lists are generated from one content data.

When a menu item “reproduce the play list instead” 720c of the selection menu image 723 is selected, a CPU 160 allows a selection menu display control section 130b to display the selection menu image 726 on a display section 2. The selection menu image 726 displays play lists of all play list IDs associated with content IDs. Here, two play lists are generated on the basis of one content data, and the selection menu image 726 includes a menu item “Play List 1” 720n and a menu item “Play List 2” 720o. The menu item “Play List 1” 720n and the menu item “Play List 2” 720o preferably display play list names given by a user. When the menu item “Play List 1” 720n or the menu item “Play List 2” 720o is selected, the CPU 160 allows a recording and reproducing control section 12 to perform the reproduction of the content data based on the selected play list.

In a case where the CPU 160 determines that the menu item “Play List 1” 720n was selected from the selection menu image 726, the CPU allows the selection menu display control section 130b to display the selection menu image 727 on the display section 2. The selection menu image 727 includes the same menu items as those described above except a menu item “reproduce the different play list” 720p, and the menu items are not especially described.

When the menu item “reproduce the different play list” 720p is selected, the CPU 160 displays, on the display section 2, the play lists of all the play list IDs associated with the content IDs. Since two play lists are generated in the present embodiment, the CPU 160 may start the reproduction of the content data based on Play List 2 which is not selected in the selection menu image 726. Alternatively, the CPU 160 may display a selection menu image for Play List 2 on the display section 2 in the same manner as in the selection menu image 727.

When the menu item “reproduce the play list instead” 720c is selected in the selection menu image 723, the CPU 160 may allow the selection menu display control section 130b to display the selection menu image 728 on the display section 2. The selection menu image 728 includes menu items 720q, 720r. The other items are the same as those of the selection menu image 725 shown in FIG. 10, and hence the description thereof is omitted. Preferably, as menu item “Play List 1” 720q and the menu item “Play List 2” 720r, the play list names given by the user are displayed. When the menu item “Play List 1” 720q or the menu item “Play List 2” 720r is selected, the CPU 160 allows the recording and reproducing control section 12 to perform the reproduction of the content data based on the selected play list. In a case where the CPU 160 determines that the menu item “Play List 1” 720q was selected in the selection menu image 728, the CPU allows the selection menu display control section 130b to display the selection menu image 727 on the display section 2. The subsequent control is the same as the above-mentioned control, and hence the description thereof is omitted.

In the third embodiment, when the selection menu image 728 is displayed and a menu item “delete the play list” 720k is selected, the CPU 160 controls the selection menu display control section 130b so as to display an image inquiring about the play list to be deleted on the display section 2. The user performs an operation of selecting the item of the play list name to be deleted to determine the selection. Based on an operation signal, the CPU 160 deletes the selected play list from a play list storage section 18b. In a case where the menu item “delete the play list” 720k is selected while the selection menu image 727 is displayed on the display section 2, the CPU 160 may delete the selected play list, that is, Play List 1 here.

It is to be noted that as to content data in which the reproduction of the play list has been selected once, an operation of reproducing from the interrupted point of the play list is prioritized when the content data is next selected. Therefore, the menu item including the item of the reproduction of the play list is displayed on the display section 2 as in the selection menu image 727.

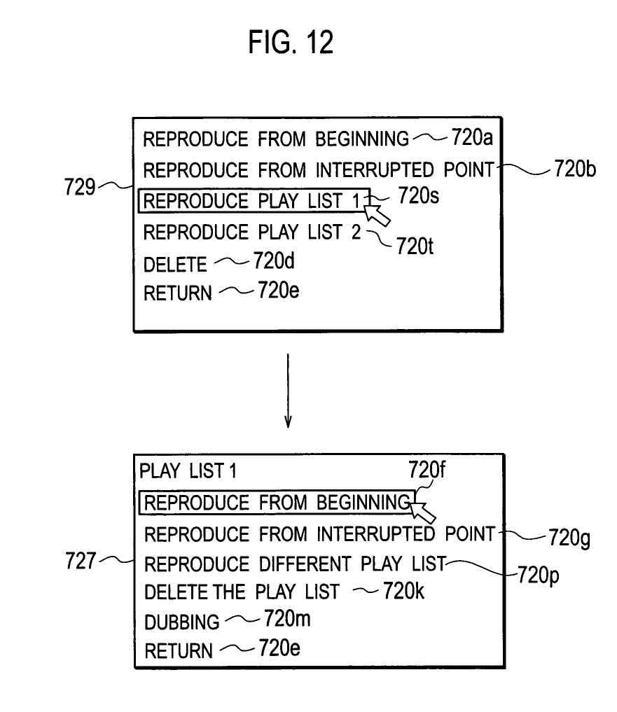

The CPU 160 may allow the selection menu display control section 130b to display a selection menu image 729 shown in FIG. 12 instead of the selection menu image 723. The selection menu image 729 includes a menu item “reproduce Play List 1” 720s and a menu item “reproduce Play List 2” 720t instead of the menu item 720c included in the selection menu image 723. Preferably, as Play List 1 and Play List 2, the play list names given by the user are displayed in the same manner as described above. When the menu item “reproduce Play List 1” 720s is selected, the CPU 160 controls the selection menu display control section 130b so as to display the selection menu image 727 on the display section 2. The subsequent control is the same as described above, and hence the description thereof is omitted.

The recording and reproducing device 101 stores the play list generated on the basis of the content data (play list generation processing). Moreover, the recording and reproducing device 101 can display an image based on the content data, and display a menu item for instructing various types of control including the reproduction of the content data with respect to the content data selected by the user (play list display processing, menu image display processing).

The user can confirm whether or not the play list using the content data to be viewed is present, in a case where the icon 530 is displayed on a screen where a list of images based on the content data shown in FIG. 8 is displayed. Alternatively, the user can confirm the presence of the play list with the selection menu images 720, 721 displayed when the content data is selected. In a case where the content data based on which the play list is prepared is selected, as described above, the menu items indicating the reproduction of the play list, for example, the menu item “reproduce the play list instead” 720c, the menu item “Play List 1” 720q, the menu item “reproduce Play List 1” 720s and the like in the selection menu image are displayed on the display section 2 as described above.

In the recording and reproducing device 101, when the icon 530 is associated with the image based on the content data and displayed on the display section 2, the user can easily visually confirm that the play list based on the content data is generated. Furthermore, in the recording and reproducing device 101, when the menu item indicating the reproduction of the play list is displayed, the user can select the reproduction of the content data based on the play list.

According to the recording and reproducing device of the present invention, in a case where the play list using the content data to be viewed is stored in the recording and reproducing device, the user can select the reproduction of the content data itself and the reproduction of the content data based on the play list.

It should be understood that many modifications and adaptations of the invention will become apparent to those skilled in the art and it is intended to encompass such obvious modifications and changes in the scope of the claims appended hereto.

What is claimed is:

1. A recording and reproducing device comprising:
a recording and reproducing control section which controls recording and reproducing of content data;
a content recording section which records the content data;
a play list generating section which generates a play list indicating an order of reproduction of scenes that are at least a part of the content data based on one or a plurality of content data recorded in the content recording section;
a play list storage section which stores the play list therein;
a link information storage section which stores link information in which content data identification information for identifying the content data recorded in the content recording section is associated with play list identification information for identifying the play list; and
a display control section which displays, on a display section, a list of the content data prepared on the basis of the at least a part of the content data recorded in the content recording section and which adds identification information indicating presence of the play list prepared on the basis of the content data to the content data as the base of the play list stored in the play list storage section, based on the link information, to display the content data with the identification information on the display section.

2. The recording and reproducing device according to claim 1, wherein the list of the content data indicates at least one of a thumbnail image based on the content data and meta data of the content data.

3. A recording and reproducing device comprising:
a recording and reproducing control section which controls recording and reproducing of content data;
a content recording section which records the content data;
a play list generating section which generates a play list indicating an order of reproduction of scenes that are at least a part of the content data, based on one or a plurality of content data recorded in the content recording section;
a play list storage section which stores the play list therein;
a link information storage section which stores link information in which content data identification information for identifying the content data recorded in the content recording section is associated with play list identification information for identifying the play list; and
a display control section which displays, on a display section, a list of the content data prepared on the basis of the at least a part of the content data recorded in the content recording section and, when one of the content data included in the list of the content data is selected and the play list that is generated on the basis of the selected content data is determined to be stored in the play list storage section based on the link information, displays, on the display section, a selection menu image having a menu for reproducing the play list that is generated on the basis of the selected content data.

4. The recording and reproducing device according to claim 3, wherein the display control section adds identification information indicating presence of the play list prepared on the basis of the content data to the content data as the base of the play list stored in the play list storage section, based on the link information, to display the content data with the identification information on the display section.

5. The recording and reproducing device according to claim 3, wherein the display control section displays, on the display section, a selection menu image having a menu for reproducing a plurality of play lists, respectively, when the plurality of play lists prepared on the basis of the selected content data are determined to be stored in the play list storage section.
